(19) United States
(12) Patent Application Publication
(10) Pub. No.: US 2026/0350367 A1
(43) Pub. Date: Nov. 5, 2026

(54) CONDITIONAL INFERENCE-TIME POLICY ENFORCEMENT SYSTEM FOR GENERATIVE AI MODELS

(71) Applicant: OpenAI OpCo, LLC, San Francisco, CA (US)

(72) Inventors: William Douglas, San Francisco, CA (US); Melody Yun Jia Guan, Belmont, CA (US); Kyle Miller, Berkeley, CA (US); Andrea Vallone, San Francisco, CA (US); Li Weng, Hillsborough, CA (US); Jieqi Yu, Alameda, CA (US); Chong Zhang, Redwood City, CA (US); Eric Zhang, Danville, CA (US)

(21) Appl. No.: 19/353,131

(22) Filed: Oct. 8, 2025

Related U.S. Application Data
(60) Provisional application No. 63/798,123, filed on May 1, 2025.

(51) Int. Cl. G06N 3/0475; G06N 3/042

(52) U.S. Cl. CPC G06N 3/0475; G06N 3/042

(57) ABSTRACT

The present disclosure relates to systems, non-transitory computer-readable media, and methods for providing policy guidance to a generative artificial intelligence model. In particular, in some embodiments, the disclosed systems access, via a generative artificial intelligence system, user message information corresponding to a user query. In addition, in some embodiments, the disclosed systems compare the user message information with a set of policies stored in a policy database for the generative artificial intelligence system. Moreover, in some embodiments, the disclosed systems determine that the user message information corresponds with a policy of the set of policies. Furthermore, in some embodiments, the disclosed systems send, to a generative artificial intelligence model of the generative artificial intelligence system, a policy guidance associated with the policy for tailoring a response to the user query.

### RELATED APPLICATIONS

This application claims priority to and the benefit of United States Provisional Patent Application No. 63/798,123 filed on May 1, 2025, the contents of which are hereby incorporated by reference herein in their entirety.

### BACKGROUND

Generative artificial intelligence systems, including large language models (“LLMs”), are increasingly used to process natural language queries and generate responses for end users. Traditional LLMs are trained on large datasets and produce outputs based on patterns learned during training. However, these models typically lack the ability to adapt their responses dynamically based on regulatory requirements, compliance rules, safety guidelines, or other needful constraints on model behavior.

Indeed, existing generative AI systems often struggle with accuracy and reliability of generated content when responding to user queries, particularly in scenarios requiring time-sensitive or domain-specific information. Because most models are trained on static datasets, they often provide outdated or incomplete answers when queried about evolving topics, such as election deadlines, regulatory updates, or breaking news. Furthermore, attempts to hard-code instructions into static system messages do not effectively solve this problem, as they lack contextual awareness and cannot dynamically adapt based on user intent or regional considerations. Moreover, when inaccurate responses are generated, they can erode user trust and, in certain domains—such as voting information, medical advice, or legal guidance—pose significant compliance and safety risks.

Additionally, existing generative AI systems often lack the flexibility and efficiency required to adapt model behavior in response to evolving requirements for safety and regulatory compliance. Indeed, traditional solutions often rely on retraining or fine-tuning models, which is computationally expensive, slow to deploy, and unsuitable for scenarios requiring rapid updates, such as regulatory changes or emerging safety concerns. Alternative approaches, such as embedding static instructions in system messages, are similarly inefficient because they apply globally to all conversations, regardless of context, and require frequent manual updates to remain relevant. These static methods also introduce risks of instruction conflicts when multiple teams modify model behavior simultaneously. As a result, existing systems cannot efficiently deliver targeted, conditional interventions or tailor responses to individual users, jurisdictions, or scenarios without significant engineering overhead.

These along with additional problems and issues exist with regard to existing generative artificial intelligence systems.

### BRIEF SUMMARY

Embodiments of the present disclosure provide benefits and/or solve one or more of the foregoing or other problems in the art with systems, non-transitory computer-readable media, and methods for providing real-time policy guidance to generative artificial intelligence models. To illustrate, in one or more embodiments, the disclosed systems dynamically tailor model outputs based on a predefined policy database. In some embodiments, the disclosed systems utilize message scanning to monitor a conversation of a large language model and determine whether one or more policies apply to a user prompt for the large language model. Upon determining a match between a user message and a policy from the policy database, in one or more embodiments, the disclosed systems retrieve policy guidance to inject into the context of the large language model. In one or more embodiments, the disclosed systems generate a temporary system message to provide the policy guidance to the large language model. Moreover, in some embodiments, the disclosed systems utilize a tool-based policy retrieval technique, whereby the large language model calls a policy guidance tool to access the applicable policy.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a high-level architecture of a generative artificial intelligence system for implementing large language models and other generative models in accordance with one or more embodiments.

FIG. 2 illustrates a diagram of an environment in which a policy guidance system operates in accordance with one or more embodiments.

FIGS. 3A–3C each illustrate an overview of the policy guidance system determining policy guidance to apply in conjunction with a generative artificial intelligence model in accordance with one or more embodiments.

FIG. 4 illustrates the policy guidance system implementing tool calls for a large language model to determine and provide policy guidance in accordance with one or more embodiments.

FIG. 5 illustrates the policy guidance system monitoring a conversation of a large language model to determine and provide policy guidance in accordance with one or more embodiments.

FIG. 6 illustrates the policy guidance system providing a policy-authoring assistant for editing policies within a policy database in accordance with one or more embodiments.

FIGS. 7A–7C illustrate graphical user interfaces showing outputs from a large language model tailored according to policy guidance from the policy guidance system in accordance with one or more embodiments.

FIG. 8 illustrates a flowchart of a series of acts for providing policy guidance to a generative artificial intelligence model in accordance with one or more embodiments.

FIG. 9 illustrates a block diagram of an example computing device for implementing one or more embodiments of the present disclosure.

FIG. 10 illustrates a network environment of a generative artificial intelligence system in accordance with one or more embodiments.

### DETAILED DESCRIPTION

This disclosure describes one or more embodiments of a policy guidance system that provides inference-time policy guidance to generative artificial intelligence models. To illustrate, the policy guidance system can scan messages of a conversation with a large language model to determine applicable policies based on a user prompt to the large language model. Upon determining a match between a user message and a policy from a policy database, the policy guidance system can retrieve policy guidance to inject into the context of the large language model. For example, the policy guidance system can generate a temporary system message to provide the policy guidance to the large language model. Moreover, in some embodiments, the policy guidance system utilizes a tool-calling technique for identifying policy guidance. For example, the policy guidance system receives a tool call from the large language model to determine whether one or more policies are applicable to a user message within the conversation.

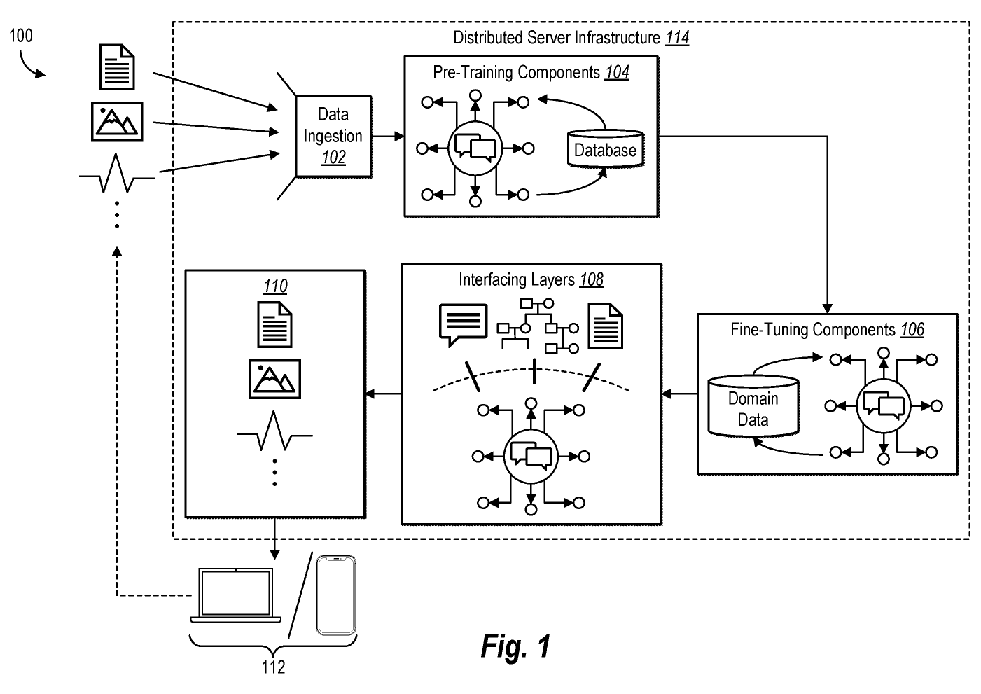

FIG. 1 illustrates a high-level architecture of a generative artificial intelligence (“AI”) system 100 for implementing large language models and other generative models to enable natural language processing, conversational interfaces, multimodal content generation, and analysis in accordance with one or more embodiments. The generative AI system 100 may include data ingestion pipelines 102, pre-training components 104, fine-tuning components 106, interfacing layers 108, and supporting hardware in the form of a distributed server infrastructure 114.

As used herein, the term “generative model” refers to a machine learning model that is configured to generate new data samples that are statistically consistent with the data on which the model was trained. Generative models may include, but are not limited to, large language models, diffusion models, variational autoencoders, generative adversarial networks, and multimodal transformer models. Generative models may be configured to generate outputs across various modalities, including text, images, audio, and video, either independently or conditionally based on input data from the same or a different modality. For example, a generative model may generate an image based on a textual prompt, generate speech based on textual input, or generate text based on prior conversational context, and may operate using probabilistic or iterative denoising methods to produce high-quality, contextually appropriate outputs.

As used herein, the term “large language model” (or “LLM”) refers to a computational model configured to process and generate human-readable text by learning statistical and contextual relationships within natural language data using machine learning techniques. An LLM typically comprises a deep neural network architecture, such as a transformer-based architecture with multiple layers and attention mechanisms, and is trained on large corpora of text using objectives such as masked language modeling, causal language modeling, or autoregressive prediction. The LLM may include billions or trillions of parameters and is capable of performing a variety of language tasks, including but not limited to text generation, summarization, translation, and question answering, by generating outputs based on input prompts in a contextually relevant manner.

Relatedly, the term “machine learning model” refers to a computational construct comprising one or more algorithms and associated parameters that are configured to perform tasks by identifying patterns or relationships within data. A machine learning model may be trained using supervised, unsupervised, semi-supervised, or reinforcement learning techniques, where the model parameters are adjusted based on input data to minimize a loss function or maximize a reward signal. The machine learning model may include, but is not limited to, neural networks (e.g., convolutional neural networks, recurrent neural networks, transformer models), decision trees, support vector machines, or ensemble models, and may be configured to perform tasks such as classification, regression, clustering, anomaly detection, or data generation. A machine learning model may operate on structured, unstructured, or multimodal data and may generate outputs that are used for predictions, decisions, or content generation based on learned representations of input data.

Additionally, the term “neural network” refers to a computational model comprising multiple interconnected processing elements, often referred to as neurons or nodes, that are organized into layers including an input layer, one or more hidden layers, and an output layer. Each neuron in the neural network applies a transformation, which may include a weighted sum of inputs followed by a non-linear activation function, to produce an output that is transmitted to subsequent neurons in the network. Neural networks are configured to learn representations of data by adjusting the weights and biases of the connections between neurons during a training process that minimizes a loss function. The neural network may include various architectures, including but not limited to feedforward neural networks, convolutional neural networks (CNNs), recurrent neural networks (RNNs), and transformer-based networks (e.g., LLMs), and may be utilized for tasks such as classification, regression, pattern recognition, natural language processing, and generative modeling across structured, unstructured, or multimodal data.

The data ingestion pipelines 102 of the generative AI system 100 may receive and preprocess large volumes of structured and unstructured data, including text corpora, image datasets, video datasets, and audio datasets, to support diverse generative model training. Preprocessing may include deduplication, tokenization, normalization, feature extraction (e.g., spectrogram generation for audio), and content safety filtering, preparing data for effective distributed training across server devices.

The pre-training components 104 of the generative AI system 100 may utilize transformer-based architectures for LLMs, as well as additional generative models such as diffusion models for image generation, autoencoders for representation learning, and multimodal transformer models for cross-domain generation tasks. These models may be configured with deep neural network stacks to capture hierarchical, semantic, and contextual relationships within the data.

The generative AI system 100 may employ diffusion models for image and video generation, where the models learn to iteratively denoise random noise into structured outputs conditioned on textual or other modality inputs. The generative AI system 100 may train these models using score-based or denoising diffusion probabilistic methods across distributed server devices within the distributed server infrastructure 114.

The generative AI system 100 may also implement speech generation models, including text-to-speech (TTS) systems using autoregressive or non-autoregressive architectures, and audio diffusion models capable of generating high-fidelity waveforms conditioned on linguistic and prosodic features. Feature extraction components may preprocess audio data to create Mel-spectrograms or other representations used during model training using the pretraining components 104.

Specialty server devices within the generative AI system 100, such as those of the distributed server infrastructure 114, may include GPUs, TPUs, or custom AI accelerators designed for high-throughput operations supporting both transformer and diffusion model training. These servers may differ from ordinary servers by incorporating high-bandwidth memory (HBM), advanced interconnects (e.g., NVLink, PCIe Gen5), and thermal and power management systems optimized for large-scale generative model workloads.

The generative AI system 100 may store shard-specific checkpoints, intermediate latents, and optimizer states for large-scale diffusion models, LLMs, and multimodal models on high-speed local or network-attached storage within the specialty servers, enabling resumption of training and inference jobs after interruptions or updates.

The fine-tuning components 106 of the generative AI system 100 may adapt generative models to specific user tasks or domain tasks, such as personalized content generation, domain-specific summarization, image style transfer, or voice cloning. Fine-tuning may involve supervised fine-tuning on task-specific datasets and reinforcement learning with human feedback (RLHF) where applicable, with data and gradients distributed across server devices for scalable operation.

The interfacing layers 108 of the generative AI system 100 may handle user prompts for LLM-based text generation, text-to-image generation requests, and speech synthesis requests. The system may tokenize or encode user prompts, generate conditioning latents where applicable (e.g., CLIP embeddings for image generation), and distribute inference tasks across server clusters for each modality-specific generative model. The interfacing layers 108 may include computer scripts, subroutines, or integrated tools for processing prompts, implementing models, and/or performing API calls to supplement and/or augment generative functions of LLMs and other models of the generative AI system 100. In some embodiments, the interfacing layers 108 include databases for accessing stored content (e.g., a vector database of content vectors for comparing with prompt vectors or query vectors) for contextual augmentation of model operation (e.g., for retrieval-augmented generation and its analogs). In some embodiments, the interfacing layers 108 integrate functionality from third-party systems (e.g., external to the generative AI system 100 and/or the distributed server infrastructure 114) into the generative AI system 100 using APIs and/or particular communication protocols to interact with generative model data (e.g., to execute generated code).

As illustrated in FIG. 1, the generative AI system 100 generates generative output 110. The generative AI system 100 can generate the generative output 110 in the form of text responses, images, videos, audio clips, or other multimodal digital content. The generative AI system 100 can generate the generative output 110 using the interfacing layers 108 in conjunction with one or more trained (e.g., pre-trained and fine-tuned, using the described components) generative models, including LLMs and others described herein.

In some embodiments, the generative AI system 100 generates the generative output 110 over one or more conversational interactions or turns with client device(s) 112. Indeed, the generative AI system 100 can provide the generative output 110 for display on the client device(s) 112. In addition, the generative AI system 100 can receive additional input in the form of text-based queries or prompts, images, videos, audio clips, and/or other multimodal content as part of an ongoing conversation between the generative AI system 100 and the client device(s) 112 and/or as part of a new conversation or instantiation of the generative AI system 100.

For large generative models exceeding single-device memory, the generative AI system 100 may implement model parallelism, with different server devices processing partitions of the model during inference across the distributed server infrastructure 114, and may use activation checkpointing and memory recomputation strategies to handle resource constraints efficiently across distributed modalities.

Server devices within the generative AI system 100 may utilize high-bandwidth interconnects for low-latency tensor and latent exchange during multi-stage generation processes (e.g., latent generation followed by decoding in diffusion models). This enables the generative AI system 100 to support complex, multi-step generation tasks, such as generating text and subsequently generating images conditioned on the generated text, while maintaining low latency.

The distributed server infrastructure 114 of the generative AI system 100 may include compute clusters with racks of specialty servers interconnected with high-bandwidth networking technologies such as InfiniBand, RDMA-enabled Ethernet, or custom fabrics, and distributed storage using NVMe over Fabrics (NVMe-oF) for rapid access to large model weights, intermediate outputs, and context data during inference.

The distributed server infrastructure 114 can include safety filtering and content moderation layers that operate in parallel with inference pipelines across modalities, applying token-level filtering for LLM outputs, image or video classification for generated visual content, and audio analysis for speech outputs to ensure outputs comply with operational policies and applicable regulations.

The distributed server infrastructure 114 can include orchestration and resource management layers that dynamically allocate compute, memory, and network resources across modalities, scaling generative model training and inference in response to user demand and system load while monitoring resource health across components of the generative AI system 100.

Collectively, the architecture illustrated in FIG. 1 enables the generative AI system 100 to provide scalable, efficient, and safe generative model services across text, image, video, audio, and other modalities, leveraging specialty server devices and distributed computing for high-throughput training, fine-tuning, and inference across a wide variety of generative AI applications.

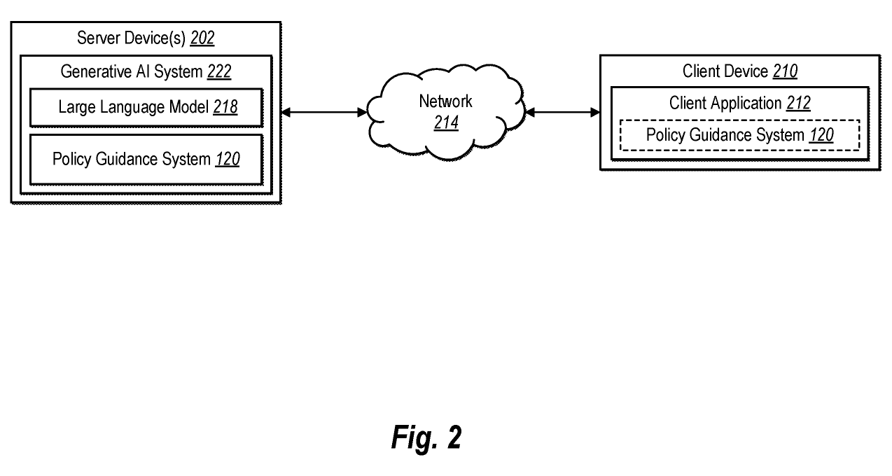

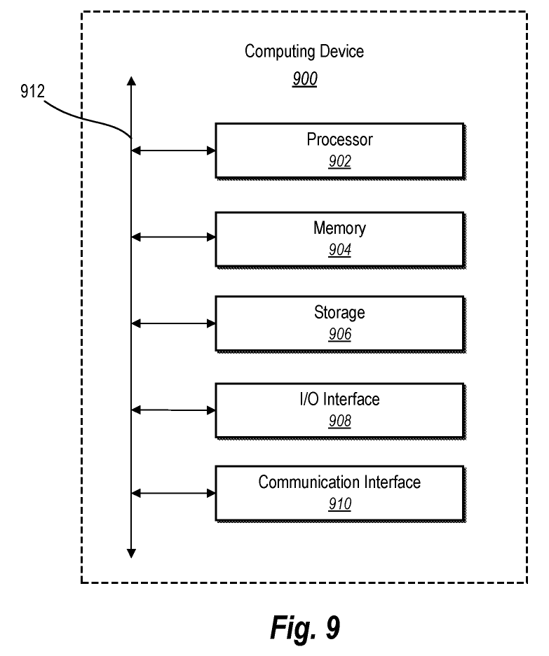

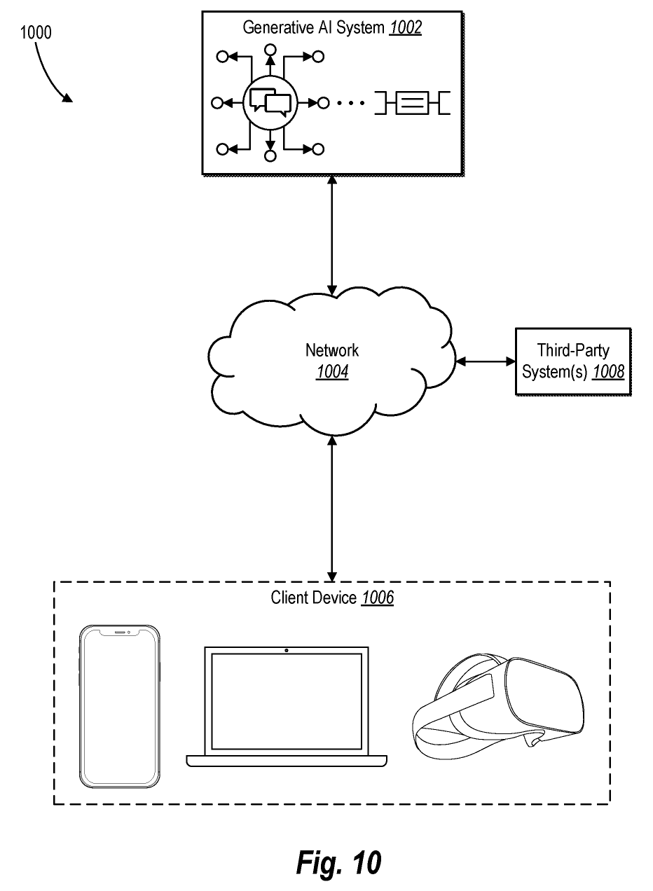

FIG. 2 illustrates a schematic diagram of an example system environment for implementing a policy guidance system 120 in accordance with one or more implementations. An overview of the policy guidance system 120 is described in relation to FIG. 2. As shown, the environment includes server device(s) 202, a client device 210, and a network 214. Each of the components of the environment can communicate via the network 214, and the network 214 may be any suitable network over which computing devices can communicate. Example networks are discussed in more detail below in relation to FIGS. 9–10.

As just mentioned, the example environment includes a client device 210. The client device 210 can be one of a variety of computing devices, including a smartphone, a tablet, a smart television, a desktop computer, a laptop computer, a virtual reality device, an augmented reality device, or another computing device as described below in relation to FIGS. 9–10. The client device 210 can communicate with the server device(s) 202 via the network 214. For example, the client device 210 can receive user input from a user interacting with the client device 210 (e.g., via a client application 212) to, for instance, interact with a generative AI system 222 located on the server device(s) 202. In addition, the policy guidance system 120 on the server device(s) 202 can receive information relating to various interactions with user interface elements based on the input received by the client device 210.

As shown, the client device 210 can include the client application 212. In particular, the client application 212 may be a web application, a native application installed on the client device 210 (e.g., a mobile application, a desktop application, etc.), or a cloud-based application where all or part of the functionality is performed by the server device(s) 202. Based on instructions from the client application 212, the client device 210 can present or display information, including a dialogue between a user and a large language model 218.

As illustrated in FIG. 2, the example environment includes the server device(s) 202. The server device(s) 202 may generate, track, store, process, receive, search, communicatively link, and transmit electronic data, such as digital content (e.g., content items), datasets, messages, searchable data, pages of data, prompts, interface elements, searches, browsing activity, browsing data, interactions with interface elements, interactions with selectable connector suggestions, and/or interactions between user accounts or client devices and the generative AI system 222. For example, the server device(s) 202 may receive data from the client device 210 in the form of a user prompt or query. Additionally, the server device(s) 202 can process inputs through the large language model 218 and return generated outputs such as text, summaries, code, or images. In some embodiments, the server device(s) 202 manage auxiliary tasks such as session tracking, context management, content filtering, and integration with databases or external tools. Indeed, the server device(s) 202 can communicate with the client device 210 to send and/or receive data via the network 214. In some implementations, the server device(s) 202 comprise a distributed server where the server device(s) 202 include a number of server devices distributed across the network 214 and located in different physical locations. The server device(s) 202 can comprise one or more content servers, application servers, communication servers, web-hosting servers, machine learning servers, and other types of servers.

As shown in FIG. 2, the server device(s) 202 can also include the policy guidance system 120 as part of the generative AI system 222. The generative AI system 222 (e.g., the generative AI system 100) can communicate with the client device 210 to perform various functions associated with the client application 212 such as receiving text prompts or queries and generating outputs using the large language model 218. The generative AI system 222 ingests structured or unstructured input data and uses the large language model 218 to intelligently produce outputs. The generative AI system 222 can further interface with backend infrastructure to manage contextual states, retrieve relevant documents, and update session-specific information. In some examples, the generative AI system 222 interacts with a cloud storage module to access user-linked content items or synchronize generated outputs with external third-party applications.

Although FIG. 2 depicts the policy guidance system 120 located on the server device(s) 202, in some implementations, the policy guidance system 120 may be implemented by (e.g., located entirely or in part on) one or more other components of the environment. For example, the policy guidance system 120 may be implemented by the client device 210 and/or a third-party device. For example, the client device 210 can download all or part of the policy guidance system 120 for implementation independent of, or together with, the server device(s) 202. In some embodiments, the policy guidance system 120 is implemented as a plug-in or modular extension associated with the large language model 218.

In some implementations, the environment may have a different arrangement of components and/or may have a different number or set of components altogether. For example, the client device 210 may communicate directly with the policy guidance system 120, bypassing the network 214. As another example, the environment can include a database located externally to the server device(s) 202 (e.g., in communication with the server device(s) 202 via the network 214), located on the server device(s) 202, on third-party servers, and/or on the client device 210.

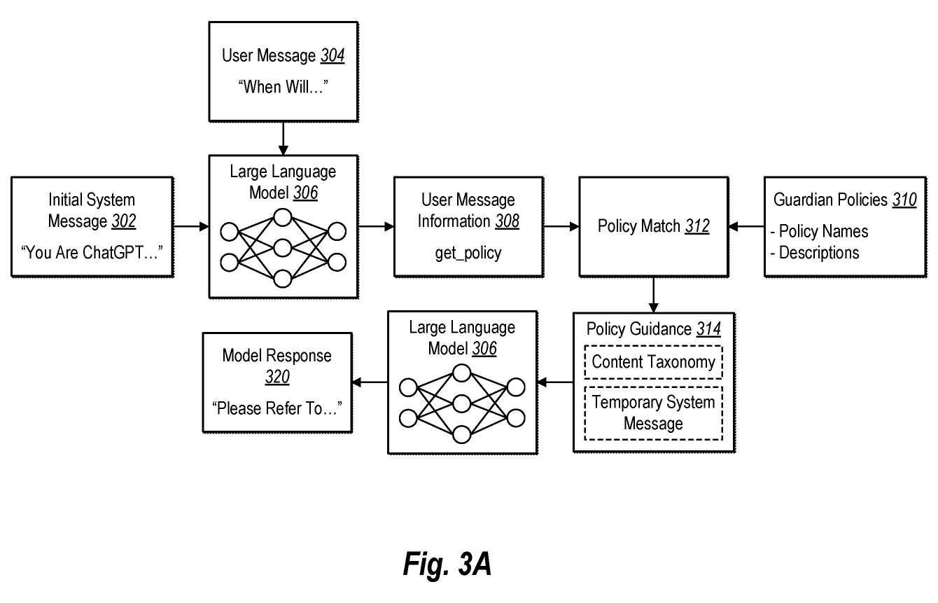

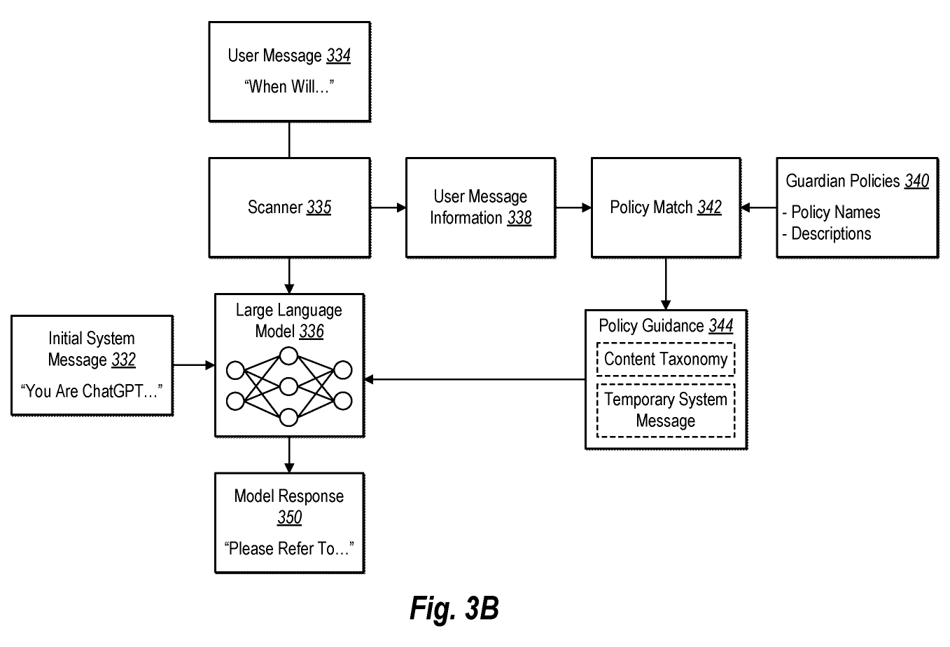

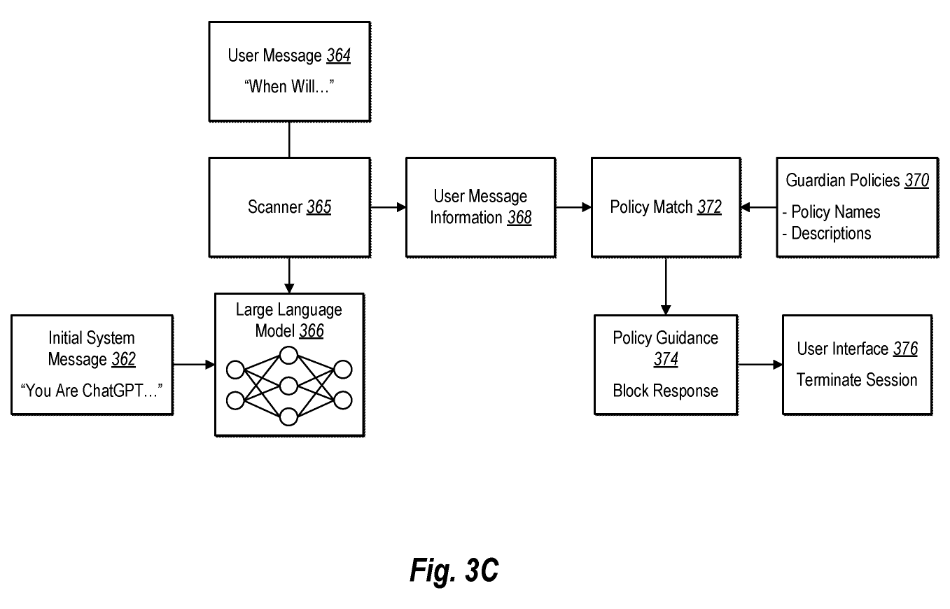

FIGS. 3A–3C each illustrate an overview of the policy guidance system 120 determining policy guidance to apply in conjunction with a generative artificial intelligence model of a generative artificial intelligence system in accordance with one or more embodiments. Specifically, FIG. 3A shows the policy guidance system 120 providing an initial system message 302 to a large language model 306 (e.g., the large language model 218). The initial system message 302 provides instructions for the large language model 306 to follow when responding to user messages. Additionally, FIG. 3A shows the large language model 306 receiving a user query 304.

Moreover, as shown in FIG. 3A, the policy guidance system 120 accesses user message information 308 corresponding to the user query 304. For example, a generative artificial intelligence system (e.g., the generative AI system 222 described above) monitors a conversation of the large language model 306 to obtain message content from the user query 304. Additionally, the generative artificial intelligence system shares message information from the message content with the policy guidance system 120. As another example, the policy guidance system 120 receives a policy lookup request that includes one or more keywords associated with the user query 304.

In addition, as shown in FIG. 3A, the policy guidance system 120 compares the user message information 308 with a set of policies 310 for the large language model 306. For instance, the set of policies 310 is stored in a policy database for the generative artificial intelligence system. The set of policies 310 can be organized by policy names and descriptions, among other facets of the set of policies 310. In some embodiments, policies may include jurisdictional attributes (e.g., country-specific applicability), temporal conditions (e.g., valid only during a certain period of time, such as during an election campaign), or context-sensitive triggers (e.g., a sequence of related messages in the conversation).

Furthermore, FIG. 3A shows that the policy guidance system 120 can determine that the user message information 308 corresponds with a policy of the set of policies 310. For example, the policy guidance system 120 determines a policy match 312 for the user message information 308. For instance, the policy guidance system 120 identifies a match criterion for the policy corresponding to the user message information 308. Match criteria may include regular expressions, classifier scores from moderation models, or hybrid checks combining broad keyword triggers with narrowed policy instructions. This can enable both deterministic matching and model-assisted interpretation.

Based on the policy match 312, the policy guidance system 120 determines a policy guidance 314 associated with the policy. For instance, the policy guidance system 120 identifies a content taxonomy for the policy of the set of policies 310 that corresponds to the user message information 308. In one or more embodiments, the policy guidance system 120 generates a temporary system message comprising policy guidance for the generative artificial intelligence model. In one or more embodiments, the policy guidance system 120 scopes the temporary system messages to a single generation turn, after which they are withdrawn to avoid persistent influence on the large language model 306, and to reduce discoverability of the policy guidance by outside parties. By withdrawing the temporary system message from the large language model 306 after a turn of the conversation, the policy guidance system 120 can help to prevent user queries from unintentionally triggering policy behavior in turns that are unrelated to the subject matter of the policy.

Moreover, as shown in FIG. 3A, the policy guidance system 120 sends the policy guidance 314 to the generative artificial intelligence model. For example, the policy guidance system 120 sends the policy guidance 314 to the large language model 306 for tailoring a response 320 to the user query 304. To illustrate, the policy guidance system 120 sends a policy guidance message (e.g., as a temporary system message) containing the policy guidance 314 to the large language model 306. In certain embodiments, the policy guidance system 120 issues policy guidance that directs the large language model 306 to refuse a response entirely. Moreover, in one or more embodiments, the policy guidance system 120 may require the large language model 306 to use another tool such as a browser for real-time retrieval of information. Furthermore, the policy guidance system 120 may instruct the model to include a disclaimer with the response in the user interface.

FIG. 3B illustrates the policy guidance system 120 determining policy guidance for a generative artificial intelligence model in accordance with one or more embodiments. In particular, FIG. 3B shows the policy guidance system 120 providing an initial system message 332 to a large language model 336 (e.g., the large language model 218). The initial system message 332 provides instructions for the large language model 336 to follow when responding to user messages.

Additionally, FIG. 3B shows the policy guidance system 120 accessing a user message 334 via message scanner 335. For example, the scanner 335 can scan for user messages routed for the LLM to send user messages to the policy guidance system 120. The policy guidance system 120 can receive the user message 334 and determine user message information 338 corresponding to the user message 334 prior to the user message 334 being submitted to the large language model 336. Accordingly, the policy guidance system 120 can determine a policy match and provide policy guidance 344 to the large language model 334 so the large language model 336 processes the user message 334 and the policy guidance 344 together. For example, the large language model 336 pauses on processing the user message until receiving policy guidance 344, receiving a notification that there is no policy match, or waiting an amount of time without receiving policy guidance that indicates that there was not a policy match. For example, a generative artificial intelligence system (e.g., the generative AI system 222 described above) monitors or scans a conversation of the large language model 336 to obtain message content from the user message 334 and provide the user message information 338 to the policy guidance system 120 prior to routing the user message to the large language model 336.

Moreover, FIG. 3B shows the policy guidance system 120 comparing the user message information 338 with a set of policies 340 (e.g., the same as, or similar to, the set of policies 310 described above). The policy guidance system 120 can determine that the user message information 338 corresponds with a policy of the set of policies 340. For example, the policy guidance system 120 determines a policy match 342 for the user message information 338. For instance, the policy guidance system 120 identifies a match criterion for the policy corresponding to the user message information 338. Match criteria may include regular expressions, classifier scores from moderation models, or hybrid checks combining broad keyword triggers with narrowed policy instructions. This can enable both deterministic matching and model-assisted interpretation.

Furthermore, based on the policy match 342, the policy guidance system 120 can determine a policy guidance 344 associated with the policy. For instance, the policy guidance system 120 identifies a content taxonomy for the policy of the set of policies 340 that corresponds to the user message information 338. In one or more embodiments, the policy guidance system 120 generates a temporary system message comprising policy guidance for the generative artificial intelligence model. In one or more embodiments, the policy guidance system 120 scopes the temporary system messages to a single generation turn, after which they are withdrawn to avoid persistent influence on the large language model 336.

Moreover, as shown in FIG. 3B, the policy guidance system 120 sends the policy guidance 344 to the large language model 336 for tailoring a response 350 to the user message 334. In certain embodiments, the policy guidance system 120 issues policy guidance that directs the large language model 336 to refuse a response entirely. Moreover, in one or more embodiments, the policy guidance system 120 may require the large language model 336 to use another tool such as a browser for real-time retrieval of information. Furthermore, the policy guidance system 120 may instruct the large language model 336 to include a disclaimer with the response in the user interface.

FIG. 3C illustrates the policy guidance system 120 determining policy guidance for a conversation with a generative artificial intelligence model in accordance with one or more embodiments. For example, FIG. 3C illustrates an embodiment where the policy guidance system 120 determines policy guidance that blocks a response and/or terminates a conversation session. In particular, FIG. 3C shows the policy guidance system 120 receiving a user message 364 via a scanner 365 (e.g., as described above with respect to FIG. 3B). The policy guidance system 120 can determine user message information 368 corresponding to the user message 364. For example, a generative artificial intelligence system (e.g., the generative AI system 222 described above) monitors a conversation of a large language model to obtain message content from the user message 364 and provide the user message information 368 to the policy guidance system 120.

Moreover, FIG. 3C shows the policy guidance system 120 comparing the user message information 368 with a set of policies 370 (e.g., the same as, or similar to, the set of policies 310 described above). The policy guidance system 120 can determine that the user message information 368 corresponds with a policy of the set of policies 370. For example, the policy guidance system 120 determines a policy match 372 for the user message information 368. For instance, the policy guidance system 120 identifies a match criterion for the policy corresponding to the user message information 368. Match criteria may include regular expressions, classifier scores from moderation models, or hybrid checks combining broad keyword triggers with narrowed policy instructions. This can enable both deterministic matching and model-assisted interpretation.

Additionally, based on the policy match 372, the policy guidance system 120 can determine a policy guidance 374 associated with the policy. For instance, the policy guidance system 120 identifies a content taxonomy for the policy of the set of policies 370 that corresponds to the user message information 368. In one or more embodiments, the policy guidance system 120 generates a temporary system message comprising policy guidance for the generative artificial intelligence model.

Furthermore, in one or more embodiments, the policy guidance system 120 determines (e.g., based on the policy guidance 374) that a model response should be blocked. For example, the policy guidance system 120 determines that the user message 364 constitutes harmful or abusive behavior for the generative artificial intelligence model. The policy guidance system 120 can block any responses to the harmful user message. For instance, the policy guidance system 120 can send an instruction to the client device to surface a message via a user interface 376 of the client device that a response cannot be provided. As another example, the policy guidance system 120 can send an instruction to the client device to terminate the conversation session. In such an instance of terminating the session, the policy guidance system 120 can further delete or otherwise remove the conversation thread entirely from the graphical user interface of the device. In other examples, the policy guidance system 120 can further provide instructions to lock the user account, suspend the user account, or otherwise deactivate the user account depending on the user message matching a severity threshold of harm or abuse. Regardless, and as shown in FIG. 3C, the large language model 366 never provides a response based on the policy guidance system 120 blocking the response per the policy guidance 374 from the matched policy.

In some embodiments, the policy guidance system 120 maintains a policy precedence ordering that deterministically selects a single policy when multiple message‑scanning rules match a turn. The precedence ordering may be global or namespace‑scoped and prevents combinatorial interactions between policies. In the same or other embodiments, more than one policy can be applied. For example, for a single turn the policy guidance system 120 can inject a temporary system message from a highest‑priority message‑scanning policy and inject tool‑based guidance policy for that same turn. If both are present, the initial system message for the LLM may specify a fixed consumption order (e.g., scanner‑injected guidance precedes tool-based guidance, or vice-versa) to ensure deterministic model behavior.

The policy guidance system 120 provides a variety of improvements relative to existing generative artificial intelligence systems. For example, the policy guidance system 120 can dynamically retrieve and apply policy-specific guidance to improve model response accuracy while maintaining reliability and consistency of model behavior. In particular, the policy guidance system 120 improves the accuracy and reliability of generative AI systems by dynamically tailoring model responses based on policy-guided interventions rather than relying on static instructions or retraining. For example, by comparing each user message against a policy database and injecting temporary, context-specific system messages when a match is detected, the policy guidance system 120 helps to ensure that responses remain consistent with authoritative policies, up-to-date information, and compliance requirements.

This approach helps to prevent large language models from generating outdated, incomplete, or conflicting answers, particularly in domains where precision is critical and/or governed by regulatory compliance and safety-related inquiries. As discussed in further detail below, because the policy guidance system 120 applies policy guidance when relevant, withdrawing the policy guidance for the next turn afterward, the large language model avoids cross-contamination between unrelated queries while preserving its ability to generate accurate responses in other contexts. As a result, the policy guidance system 120 provides a highly adaptive mechanism for maintaining reliable outputs without sacrificing overall model performance or requiring expensive retraining cycles.

Furthermore, the policy guidance system 120 provides a dynamic, policy-driven framework that achieves rapid, context-aware behavior updates for generative artificial intelligence models without requiring model retraining or destabilizing core model performance. Thus, the policy guidance system 120 offers technical advantages in flexibility and efficiency by enabling generative AI systems to dynamically modify their behavior without retraining or global reconfiguration. Unlike traditional approaches that require extensive fine-tuning or static system message updates, the policy guidance system 120 leverages a policy database and real-time policy guidance injection to deliver targeted, context-aware interventions only when user prompts relate to one or more policies within the policy database. By inserting temporary system messages on a per-query basis, the policy guidance system 120 flexibly guides model responses without changing core model behavior for unrelated conversation topics, thereby preserving baseline model performance.

Moreover, the policy guidance system 120 allows administrators to quickly add, remove, or modify policies through an intuitive user interface, with policy updates taking effect immediately across the system. As a result, the policy guidance system 120 enables rapid adaptation to evolving regulations, safety concerns, or user-specific requirements while maintaining high efficiency, scalability, and minimal operational overhead. In addition, in one or more embodiments, the policy guidance system 120 can generate data that is later used to post-train the generative artificial intelligence models to natively handle guided behaviors without policy injection. Thus, by supporting future post-training improvements based on collected intervention data, the policy guidance system 120 can further enhance safety, regulatory compliance, adaptability, and flexibility of the underlying generative artificial intelligence models.

Moreover, the policy guidance system 120 can customize policy based on specific user attributes. For example, the policy guidance system 120 can receive contextual parameters (e.g., country, locale, time window, device type, application surface). Based on the contextual parameters, the policy guidance system 120 can dynamically return specialized guidance given a specified context. Accordingly, the policy guidance system 120 provides increased flexibility compared to past systems that allows for a level of customization across different contextual situations while maintaining low latency and high recall.

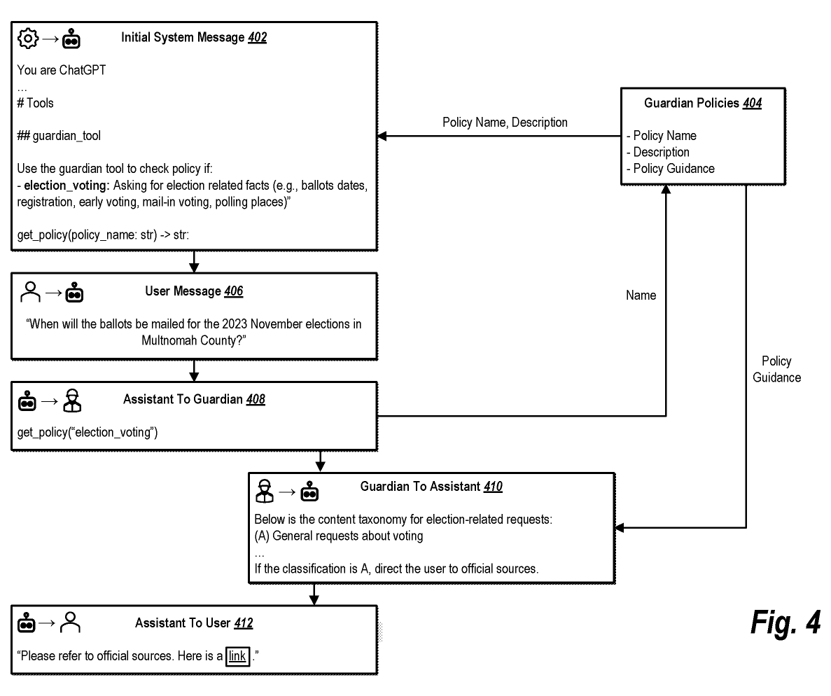

As mentioned, in some embodiments, the policy guidance system 120 uses tool calling to provide policy guidance to a generative AI model. For instance, FIG. 4 illustrates the policy guidance system 120 overseeing tool calls of a large language model to determine and provide policy guidance in accordance with one or more embodiments.

Specifically, FIG. 4 shows a generative artificial intelligence system generating an initial system message 402 for a generative artificial intelligence model (e.g., a large language model, such as the large language model 306). For example, the initial system message 402 includes instructions, settings, and/or specific configurations to guide the response behavior of the large language model. The initial system message 402 can include settings and instructions for calling tools, such as a policy guidance tool. In the example shown in FIG. 4, the initial system message 402 includes instructions for calling a guardian tool to check for policies around election related facts, such as ballot dates, registration, early voting, mail-in voting, and polling places. Additionally, the initial system message 402 includes formatting instructions for the large language model to format a call to the guardian tool.

In addition, FIG. 4 shows an example process for calling the policy guidance tool. In particular, the policy guidance system 120 includes a set of policies 404 (e.g., illustrated as “Guardian Policies”) that include policy names and descriptions, as well as policy guidance associated with the policies in the set of policies 404. The policy guidance system 120 can include policy names and descriptions in the initial system message 402 to apprise the large language model of the various policies within the set of policies 404.

As also shown in FIG. 4, the large language model can receive a user message 406 (e.g., a user query). The user message 406 can prompt the large language model to answer a question or to otherwise provide information to a user. In the example shown, the user message 406 asks when ballots will be mailed for an election.

The policy guidance system 120 can determine that the user message 406 relates to a policy of the set of policies 404 (e.g., an elections and voting policy) based on the policy descriptions included in the initial system message 402. Moreover, the policy guidance system 120 can provide the pertinent policy to the large language model via a tool call 408 that looks up the pertinent policy. For instance, the large language model sends the tool call 408 naming the policy, and the policy guidance system 120 searches the set of policies 404 for the corresponding policy guidance.

Stated differently, in one or more embodiments, the policy guidance system 120 receives a policy lookup request with a keyword (e.g., elections/voting) associated with the user query. For example, the keyword names or otherwise indicates the desired policy. The large language model can determine the pertinent keyword based on the policy descriptions provided in the initial system message 402. For instance, the large language model compares content of the user message 406 with the descriptions of the policies in the set of policies 404 to determine the relevant policy name. The large language model can generate the policy lookup request by including the policy name in the tool call syntax provided in the initial system message 402.

Moreover, upon receiving the policy lookup request, the policy guidance system 120 can provide a policy guidance message 410 to the large language model. For example, the policy guidance system 120 identifies a content taxonomy corresponding to the keyword in the policy lookup request. In this way, the policy guidance system 120 can determine that the user message information (e.g., the keyword associated with the user message 406) corresponds with a policy of the set of policies 404.

Furthermore, the policy guidance system 120 can provide the policy guidance message 410 as a temporary system message. For example, the policy guidance message 410 can include temporary instructions for the large language model that direct the large language model to respond to the user message 406 in a particular way. In the example shown, the policy guidance message 410 instructs the large language model to direct a user to official sources upon a request classified as a general request about voting. Following the policy guidance message 410, the large language model generates and provides a response 412 in line with the policy guidance. For example, the response 412 informs the user that the request about when ballots will be mailed can be answered by referring to official sources. For instance, the response 412 provides a link to official sources to find an answer to the question in the user message 406.

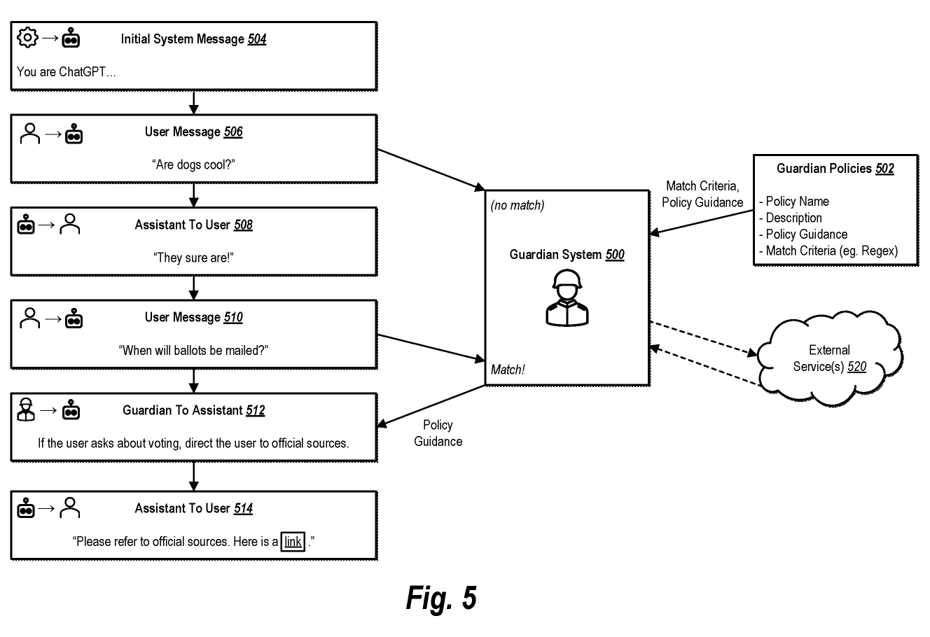

As mentioned, in some embodiments, the policy guidance system 120 uses message scanning to provide policy guidance to a generative AI model. For instance, FIG. 5 illustrates the policy guidance system 120 overseeing a conversation of a large language model to determine and provide applicable policy guidance in accordance with one or more embodiments.

To illustrate, FIG. 5 shows the policy guidance system 120 (e.g. “Guardian System 500”) monitoring user messages submitted to a large language model and providing policy guidance during message turns when the content of the user message merits providing policy guidance to the large language model. Additionally, the policy guidance system 120 accesses a policy database with a set of policies 502. The policy database can include policy names for each of the policies within the set of policies 502, as well as policy descriptions, policy guidance, and match criteria. For example, the match criteria can be formatted as regular expressions that specify match patterns in text for the policy names and/or descriptions.

In addition, FIG. 5 shows an example conversation between a user account and a generative artificial intelligence model (e.g., a large language model, such as the large language model 306). To illustrate, a generative artificial intelligence system provides an initial system message 504 to the large language model. The initial system message 504 can include instructions, settings, and/or specific configurations to guide the response behavior of the large language model.

Additionally, FIG. 5 shows a user message 506 submitted to the large language model. The user message 506 can include a query seeking information or requesting that the large language model generate content, such as text content, voice content, image content, or other content. In the example illustrated, the user message 506 asks “Are dogs cool?”. As illustrated, in one or more embodiments, the policy guidance system 120 can access the user message 506. The policy guidance system 120 reads the user message 506 to determine whether the user message 506 matches a policy of the set of policies 502. For instance, the policy guidance system 120 compares user message information (e.g., message content, an embedding of the message, keywords from the message, etc.) with the match criteria from the policy database.

In the event that the user message information corresponds with a policy (e.g., matches the match criterion associated with a policy) of the set of policies 502, the policy guidance system 120 can provide the corresponding policy guidance to the large language model. In the example shown in FIG. 5, the user message 506 does not correspond with any of the policies within the policy database. In other words, in the illustrated example, the query “Are dogs cool?” does not satisfy a match to a policy of the set of policies 502. In some embodiments, when a user message does not match any of the policies, the policy guidance system 120 does not provide policy guidance to the large language model on that turn of the conversation.

For example, when no policy guidance is provided on a particular turn of the conversation, the large language model proceeds to generate an answer to the query without any additional guidance in the system message. For instance, in response to “Are dogs cool?”, the large language model generates a response 508 that answers “They sure are!”. In some embodiments, the large language model confirms with the policy guidance system 120 that there is not any applicable policy guidance before providing a response to the user. Alternatively, or additionally, in some embodiments, the large language model waits a predetermined time (e.g., a few seconds) before providing a response to the user. For example, in one or more embodiments, the policy guidance system 120 does not provide policy guidance on a particular turn, and after the predetermined time, the large language model proceeds to provide a generated response for the user message.

As further shown in FIG. 5, the conversation can proceed with additional user messages and large language model responses. To illustrate, the user submits a user message 510. The policy guidance system 120 accesses the user message 510 to determine whether it corresponds with a policy of the set of policies 502. In the illustrated example, the user message 510 asks “When will ballots be mailed?” The policy guidance system 120 compares user message information of the user message 510 (e.g., message content, an embedding of the message, keywords from the message, etc.) with the match criteria from the set of policies 502. In the illustrated example, the user message 510 satisfies a match to a policy of the set of policies 502. Thus, the policy guidance system 120 identifies the match criterion for the policy and determines that the user message information matches the match criterion.

Upon determining that user message information satisfies a policy match criterion, the policy guidance system 120 can provide corresponding policy guidance to the large language model. For instance, the policy guidance system 120 generates a temporary system message 512 (or other instructional message for the large language model) that states the policy guidance corresponding to the applicable policy. The policy guidance system 120 provides the temporary system message 512 to the large language model for the current turn of the conversation. In the illustrated example, the temporary system message 512 instructs the large language model to direct the user to official sources upon a request that relates to voting.

As further shown in FIG. 5, the large language model continues the conversation by responding in accordance with the inserted temporary system message 512. In the illustrated example, the large language model provides a response 514 that recommends that the user refer to official sources to determine when ballots will be mailed. Moreover, as shown, the large language model can provide a link to the official sources to find the answer to the query.

In addition, in one or more embodiments, the policy guidance system 120 can utilize external service(s) 520 that provide additional information about a message. For example, the policy guidance system 120 can call a moderations API or outside classifier for additional data relating to a user message. For example, the external service(s) 520 can detect and classify sensitive content in user messages before they are processed by the large language model. As anther example, the external service(s) 520 can be called for additional user data (e.g., geolocation, historical message data, etc.). To illustrate, the policy guidance system 120 can score user messages according to various harm categories and trigger policy-guided interventions when a user message scores within a certain category. For example, when a user message scores highly for a particular category, the policy guidance system 120 can inject temporary guidance directing the large language model to provide an appropriate response, such as by providing hotline resources or blocking a response entirely.

Furthermore, in one or more embodiments, the policy guidance system 120 removes policy guidance from the large language model after the large language model uses the policy guidance. For example, the policy guidance system 120 removes a policy guidance message from the large language model after a turn of the conversation during which the large language model used the policy guidance message to tailor a response. For instance, the policy guidance system 120 removes the temporary system message 512 from a thread of system messages for the large language model after the large language model generates the response 514 to the user message 510. For example, the policy guidance system 120 deletes the policy guidance message from the thread of system messages after the large language model generates the response.

With the temporary system message 512 withdrawn from the large language model after the response 514 is provided to the user, the large language model can proceed to generate conversational responses according to the initial system message 504 (and any other inserted system messages that remain present for the large language model). Furthermore, the policy guidance system 120 can continue to monitor the conversation to access user messages and scan them for matches with the set of policies 502. Thus, the policy guidance system 120 can continue to provide appropriate policy guidance to the large language model, including repeating policy guidance that has previously been sent (e.g., if the content of the conversation warrants the repeated policy guidance).

As mentioned, in one or more embodiments, the policy guidance system 120 blocks a model response outright. For instance, in one or more embodiments, the policy guidance system 120 prevents the response 514 from being surfaced to the user device. For example, the policy guidance system 120 directs the user device to terminate the conversation with the large language model. In some embodiments, the policy guidance system 120 provides a message for display via a user interface of the user device to inform the user that the conversation has been terminated.

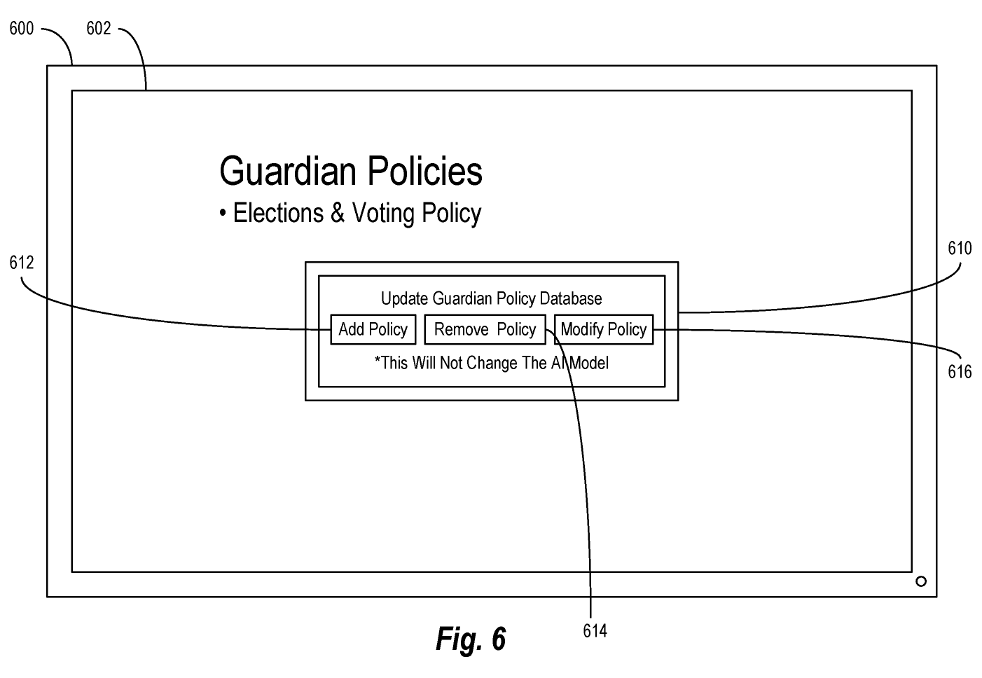

Moreover, in some embodiments, the policy guidance system 120 provides an interface for policy authoring and/or administration. In some embodiments, the policy guidance system 120 provides a policy-authoring assistant with options to edit the set of policies for a generative artificial intelligence model. For instance, FIG. 6 illustrates the policy guidance system 120 providing a user interface by which a user can edit the policies in accordance with one or more embodiments.

Specifically, FIG. 6 shows a computing device 600 with a graphical user interface 602. The computing device 600 may be assigned to a user (e.g., a policy administrator) to administer policies for a generative artificial intelligence model, such as a large language model. The policy guidance system 120 can provide an interface via which the user can edit the set of policies for the large language model. For example, the policy guidance system 120 provides a list of policies via the graphical user interface 602 and an option to update the policy database. For instance, the policy guidance system 120 provides an edit window 610 with selection buttons to edit policies. In some embodiments, the policy guidance system 120 provides an add option 612 via which one or more policies can be added to the policy database. In some embodiments, the policy guidance system 120 provides a remove option 614 via which one or more policies can be removed from the policy database. In some embodiments, the policy guidance system 120 provides a modify option 616 via which one or more policies can be changed within the policy database.

Moreover, the policy guidance system 120 can modify (e.g., based on a user input upon selection of the modify option 616) a policy by changing one or more aspects of the policy. For example, the policy guidance system 120 can update a policy name, policy description, the content of the corresponding policy guidance, and/or the match criteria for the policy. Thus, the policy guidance system 120 facilitates administration of the policy database, to include capability for updating not just the policy guidance, but also related policy data, such as policy names and match criteria.

To elaborate, the policy guidance system 120 provides the policy-authoring assistant via which a policy administrator can use the policy guidance system 120 to update the policy database. For example, the policy guidance system 120 can update the policy database by adding a new policy to the set of policies. Furthermore, the policy guidance system 120 can update the policy database by removing an existing policy from the set of policies. Additionally, the policy guidance system 120 can update the policy database by modifying a policy. Moreover, the policy guidance system 120 can modify a policy without modifying the generative artificial intelligence model. For example, in one or more embodiments, changing a policy of the set of policies does not change parameters of the model.

Indeed, by providing a mechanism for issuing policy guidance to the generative artificial intelligence model without changing the generative artificial intelligence model, the policy guidance system 120 provides several advantages over existing generative artificial intelligence systems. For example, the policy guidance system 120 enhances artificial intelligence safety without requiring additional training or finetuning of the generative artificial intelligence models. For instance, the policy guidance system 120 provides an assistant that helps increase the reliability of large language model answers by reducing errors. Moreover, the policy-authoring assistant of the policy guidance system 120 accelerates deployment of new policies and updating of existing policies without impacting the underlying language model.

In one or more embodiments, the policy guidance system 120 uses an auxiliary large language model to assist the policy administrator to format the policies. For example, the auxiliary large language model generates policy guidance and match criteria based on natural language descriptions provided by the policy administrator. Moreover, the auxiliary large language model formats the policy guidance and match criteria according to conventions of the policy guidance system 120 to ensure proper functionality of the policy database.

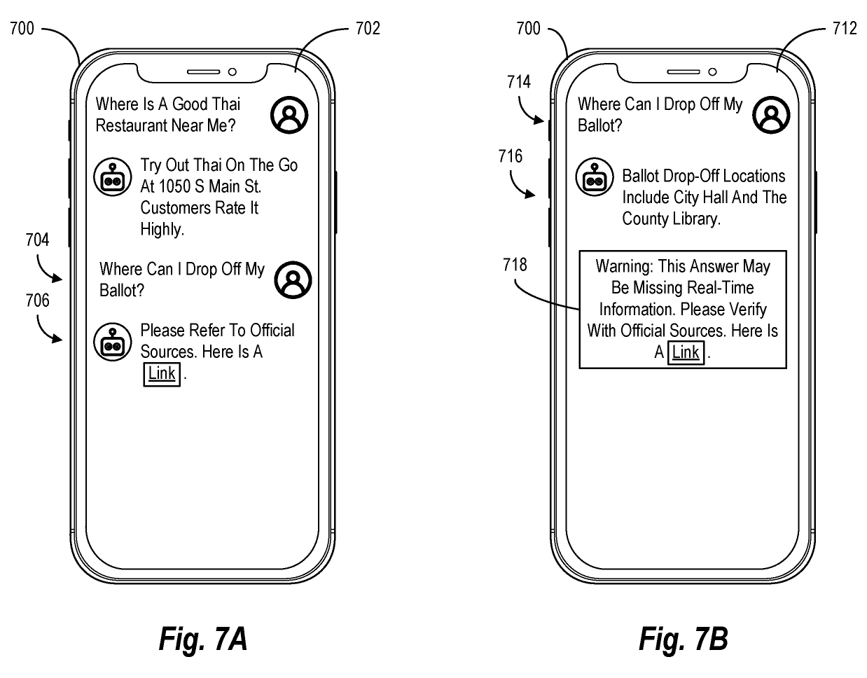

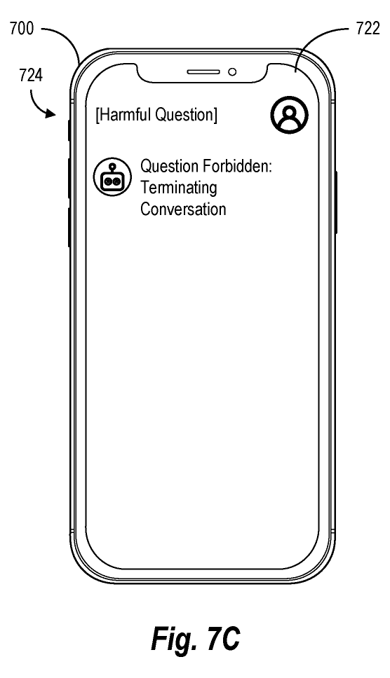

As mentioned, in some embodiments, the policy guidance system 120 instructs a generative artificial intelligence model not to provide a direct response to a particular user query. For instance, FIGS. 7A–7C illustrate graphical user interfaces showing outputs from a large language model declining to answer a user query in line with policy guidance from the policy guidance system 120, providing a supplemental message according to the policy guidance, or outright blocking an answer, in accordance with one or more embodiments.

Specifically, FIG. 7A shows a client device 700 with a graphical user interface 702 displaying a conversation between a user account and a large language model. In the example shown, the user asks the large language model for a restaurant suggestion, to which the large language model provides an answer suggesting a particular restaurant. Next, the user enters a user query 704 asking the large language model where a ballot can be dropped off. In line with a policy guidance from the policy guidance system 120, the large language model provides a response 706 that directs the user to refer to official sources to find an answer to the question of the user query 704. Moreover, as shown, the policy guidance system 120 can provide a link for the user to access the official sources to find the answer.

For instance, as with the policy guidance message 410 (described above in connection with FIG. 4) and the policy guidance contained within the temporary system message 512 (described above in connection with FIG. 5), the policy guidance system 120 issues policy guidance to the large language model that directs the large language model not to answer the specific question in the user query 704. In some embodiments, the policy guidance system 120 prevents the large language model from issuing a response to the user query 704. Moreover, in some embodiments, the policy guidance system 120 directs the large language model to explain that the large language model cannot provide a direct answer to the user query 704 and/or suggest that the user check other sources.

In some cases, the policy guidance system 120 blocks the large language model from outputting an answer when the answer would contain personally identifiable information of a person. For example, the policy guidance system 120 can block answers that are subject to privacy regulations or other compliance requirements that prohibit disclosure of personally identifiable information.

Relatedly, in one or more embodiments, the policy guidance system 120 provides a notification to supplement an answer to a user query. For example, FIG. 7B shows the client device 700 with a graphical user interface 712 displaying a conversation between a user account and a large language model. In the example shown, the user enters a user query 714 asking the large language model where a ballot can be dropped off. In accordance with a policy guidance from the policy guidance system 120, the large language model provides a response 716 that answers the question of the user query 714 (e.g., the ballot can be dropped off at city hall or the county library). Additionally, the policy guidance system 120 provides a notification 718 for display via the graphical user interface 712. The notification 718 includes a supplemental message for the large language model to include with the response 716 to the user query 714 based on the applicable policy. In the example shown, the supplemental message informs the user that the answer to the question may be missing real-time information, and suggests that the user verify the answer with official sources.

As just mentioned, in some cases, the policy guidance system 120 can append supplemental disclaimers to model responses when the model lacks access to real-time data. In this way, the policy guidance system 120 can flexibly address both safety-sensitive and compliance-driven use cases.

Additionally, in one or more embodiments, the policy guidance system 120 blocks an output to a user device based on user message information that indicates a harmful user message. For example, FIG. 7C shows the client device 700 with a graphical user interface 722 displaying a conversation between a user account and a large language model. In the example shown, the user enters a user query 724 that contains a harmful question (e.g., a question that poses an abusive use of the large language model – denoted in FIG. 7C as [Harmful Question]). In accordance with a matched policy guidance, the policy guidance system 120 blocks an answer to the harmful question. For example, in some embodiments, the policy guidance system 120 directs the large language model to not process the user query 724 and to respond with a message indicating that the user query 724 is forbidden. Alternatively or additionally, in some embodiments, the policy guidance system 120 stops the conversation immediately (e.g., without first sending the policy guidance to the large language model). For example, in response to the policy guidance system 120 detecting a harmful question, the policy guidance system 120 can provide instructions to not respond and/or automatically shut down the conversation session, e.g., close the conversation session and remove it from the graphical user interface 722.

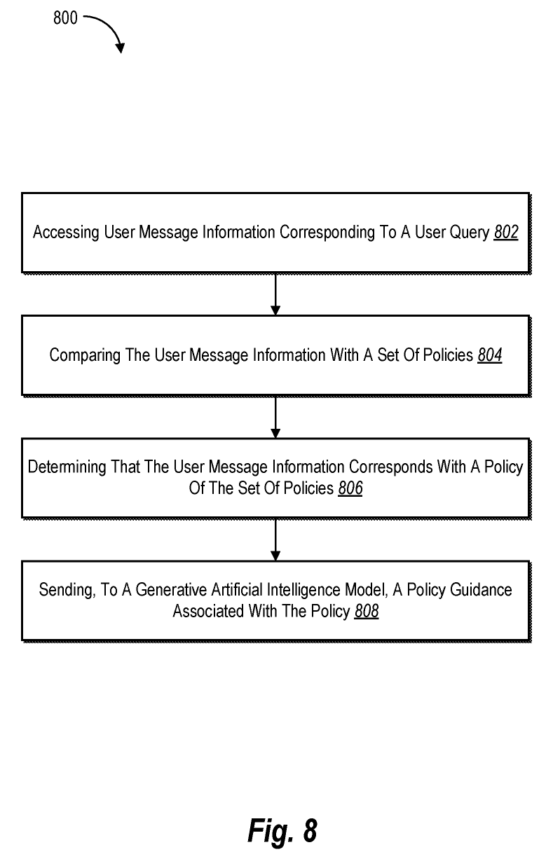

FIGS. 1–7C, the corresponding text, and the examples provide a number of different methods, systems, devices, and non-transitory computer-readable media of the policy guidance system 120 and/or the generative AI system 100. In addition to the foregoing, one or more embodiments are described in terms of flowcharts comprising acts for accomplishing a particular result, as shown in FIG. 8. In some implementations, the processes of the policy guidance system 120 and/or the generative AI system 100 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 8 illustrates a flowchart of a series of acts 800 for providing policy guidance to a generative artificial intelligence model in accordance with one or more implementations. While FIG. 8 illustrates acts according to one implementation, alternative implementations omit, add to, reorder, and/or modify any of the acts shown in FIG. 8. In one or more implementations, the acts of FIG. 8 are performed as part of a method (e.g., a computer-implemented method). Alternatively, in one or more implementations, a non-transitory computer-readable storage medium comprises instructions that, when executed by one or more processors, cause a computing device to perform the acts of FIG. 8. In some implementations, a system performs the acts of FIG. 8.

As shown in FIG. 8, the series of acts 800 includes an act 802 of accessing user message information corresponding to a user query, an act 804 of comparing the user message information with a set of policies, an act 806 of determining that the user message information corresponds with a policy of the set of policies, and an act 808 of sending, to a generative artificial intelligence model, a policy guidance associated with the policy.

In particular, in some implementations, the act 802 includes accessing, via a generative artificial intelligence system, user message information corresponding to a user query, the act 804 includes comparing the user message information with a set of policies stored in a policy database for the generative artificial intelligence system, the act 806 includes determining that the user message information corresponds with a policy of the set of policies, and the act 808 includes sending, to a generative artificial intelligence model of the generative artificial intelligence system, a policy guidance associated with the policy for tailoring a response to the user query. Additionally, in some implementations, the series of acts 800 includes generating, for the generative artificial intelligence model, a temporary system message comprising the policy guidance.

Moreover, in some implementations, the series of acts 800 includes accessing the user message information corresponding to the user query by receiving a policy lookup request with a keyword associated with the user query. Furthermore, in some implementations, the series of acts 800 includes determining that the user message information corresponds with the policy by identifying, within the set of policies, a content taxonomy corresponding to the keyword.

Moreover, in some implementations, the series of acts 800 includes accessing the user message information corresponding to the user query by monitoring a conversation of the generative artificial intelligence model. Furthermore, in some implementations, the series of acts 800 includes determining that the user message information corresponds with the policy by identifying a match criterion for the policy based on the conversation.

In addition, in some implementations, the series of acts 800 includes removing the policy guidance from a thread of the generative artificial intelligence model after the generative artificial intelligence model generates the response to the user query. Moreover, in some implementations, the series of acts 800 includes updating the policy database by adding a new policy to the set of policies. Furthermore, in some implementations, the series of acts 800 includes updating the policy database by modifying at least one policy of the set of policies without modifying parameters of the generative artificial intelligence model.

Additionally, in some implementations, the series of acts 800 includes preventing the generative artificial intelligence model from issuing the response to the user query. Furthermore, in some implementations, the series of acts 800 includes providing, for display via a graphical user interface of a client device, a supplemental message with the response to the user query based on the policy.

Moreover, in some implementations, the series of acts 800 includes receiving, from a large language model, user message information corresponding to a user query; comparing the user message information with a set of policies for the large language model; determining that the user message information satisfies a match to a policy of the set of policies; and sending, to the large language model for tailoring a response to the user query, a policy guidance message associated with the policy.

Additionally, in some implementations, the series of acts 800 includes receiving the user message information corresponding to the user query by monitoring a conversation of the large language model; comparing the user message information with the set of policies by comparing a portion of the conversation of the large language model with match criteria for the set of policies; determining that the user message information satisfies the match to the policy by identifying a match criterion within the match criteria that corresponds to the portion of the conversation; and sending the policy guidance message to the large language model by generating a temporary system message for the large language model stating the policy guidance message.

Moreover, in some implementations, the series of acts 800 includes deleting the policy guidance message from a thread of the large language model after the large language model generates the response to the user query. Furthermore, in some implementations, the series of acts 800 includes updating a policy database with a new policy for the set of policies. Moreover, in some implementations, the series of acts 800 includes updating a policy database with a change to at least one policy of the set of policies without changing the large language model.

In addition, in some implementations, the series of acts 800 includes receiving, from a generative artificial intelligence model, user message information corresponding to a user query; comparing the user message information with a set of policies for the generative artificial intelligence model; determining that the user message information matches a policy match criterion of a policy from the set of policies; and sending a temporary system message with policy guidance for the policy to the generative artificial intelligence model.

Moreover, in some implementations, the series of acts 800 includes deleting the temporary system message from a thread of the generative artificial intelligence model after the generative artificial intelligence model generates a response to the user query. Furthermore, in some implementations, the series of acts 800 includes adding a new policy to the set of policies. Additionally, in some implementations, the series of acts 800 includes modifying at least one policy of the set of policies without modifying the generative artificial intelligence model.

Moreover, in some implementations, the series of acts 800 includes receiving the user message information corresponding to the user query by monitoring a conversation of the generative artificial intelligence model; comparing the user message information with the set of policies by comparing a portion of the conversation of the generative artificial intelligence model with match criteria for the set of policies; and determining that the user message information matches the policy match criterion by identifying the policy match criterion from the match criteria based on the portion of the conversation. Furthermore, in some implementations, the series of acts 800 includes providing, for display via a graphical user interface of a client device, a supplemental message with a response to the user query based on the policy; or preventing the generative artificial intelligence model from issuing the response to the user query based on the policy.

Embodiments of the present disclosure may comprise or utilize a special purpose or general purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some implementations, computer-executable instructions are executed on a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network computers, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900, may represent the computing devices described herein (e.g., the server device(s) 202, the client device 210, etc.). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other implementations. Furthermore, in certain implementations, the computing device 900 includes fewer components than those shown in FIG. 9. Components of the computing device 900 shown in FIG. 9 will now be described in additional detail.

In particular implementations, the processor 902 includes hardware for executing instructions, such as those making up a computer program. As an example, and not by way of limitation, to execute instructions, the processor 902 may retrieve (or fetch) the instructions from an internal register, an internal cache, memory 904, or a storage device 906 and decode and execute them.

The computing device 900 includes the memory 904, which is coupled to the processor 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes the storage device 906 for storing data or instructions. As an example, and not by way of limitation, the storage device 906 can include a non-transitory storage medium described above. The storage device 906 may include a hard disk drive (“HDD”), flash memory, a Universal Serial Bus (“USB”) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, a keypad, a keyboard, a touch screen, a camera, an optical scanner, a network interface, a modem, other known I/O devices, or a combination of such I/O interfaces.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include the bus 912. The bus 912 can include hardware, software, or both that connects components of computing device 900 to each other.

FIG. 10 is a schematic diagram illustrating environment 1000 within which one or more implementations of the policy guidance system 120 can be implemented. For example, the policy guidance system 120 may be part of a generative AI system 1002 (e.g., the generative AI system 100). Generative AI system 1002 may generate, store, manage, receive, and send digital content (such as digital content items). For example, generative AI system 1002 may send and receive digital content to and from client devices 1006 by way of network 1004. In particular, generative AI system 1002 can store and manage a collection of digital content. Generative AI system 1002 can manage the sharing of digital content between computing devices associated with a plurality of users. For instance, generative AI system 1002 can facilitate a user sharing a digital content item with another user of generative AI system 1002.

In particular, generative AI system 1002 can manage synchronizing digital content across multiple client devices 1006 associated with one or more users. For example, a user may edit digital content using client device 1006. The generative AI system 1002 can cause client device 1006 to send the edited digital content to generative AI system 1002. Generative AI system 1002 then synchronizes the edited digital content on one or more additional computing devices.

In addition to synchronizing digital content across multiple devices, one or more implementations of generative AI system 1002 can provide an efficient storage option for users that have large collections of digital content. For example, generative AI system 1002 can store a collection of digital content on generative AI system 1002, while the client device 1006 only stores reduced-sized versions of the digital content. A user can navigate and browse the reduced-sized versions (e.g., a thumbnail of a digital image) of the digital content on client device 1006. In particular, one way in which a user can experience digital content is to browse the reduced-sized versions of the digital content on client device 1006.

Another way in which a user can experience digital content is to select a reduced-size version of digital content to request the full- or high-resolution version of digital content from generative AI system 1002. In particular, upon a user selecting a reduced-sized version of digital content, client device 1006 sends a request to generative AI system 1002 requesting the digital content associated with the reduced-sized version of the digital content. Generative AI system 1002 can respond to the request by sending the digital content to client device 1006. Client device 1006, upon receiving the digital content, can then present the digital content to the user. In this way, a user can have access to large collections of digital content while minimizing the amount of resources used on client device 1006.

Client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1006 may execute one or more client applications, such as a web browser (e.g., Microsoft Windows Internet Explorer, Mozilla Firefox, Apple Safari, Google Chrome, Opera, etc.) or a native or special-purpose client application to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1006 may access generative AI system 1002.

As illustrated, the generative AI system 1002 communicates with third-party system(s) 1008 by way of the network 1004. For example, the generative AI system 1002 generates computer code or scripts for execution by the third-party system(s) 1008 as part of generating an output. In some cases, the generative AI system 1002 integrates subcomponents or features of the third-party system(s) 1008 using APIs or other integrations. The third-party system(s) 1008 can include systems housed and operated on servers separate from the generative AI system 1002, such as data management systems, calendaring systems, social networking systems, search engine systems, and/or other computer systems.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
accessing, via a generative artificial intelligence system, user message information corresponding to a user query;
comparing the user message information with a set of policies stored in a policy database for the generative artificial intelligence system;
determining that the user message information corresponds with a policy of the set of policies; and
sending, to a generative artificial intelligence model of the generative artificial intelligence system, a policy guidance associated with the policy for tailoring a response to the user query.

2. The computer-implemented method of claim 1, further comprising generating, for the generative artificial intelligence model, a temporary system message comprising the policy guidance.

3. The computer-implemented method of claim 1, wherein accessing the user message information corresponding to the user query comprises receiving a policy lookup request with a keyword associated with the user query, and wherein determining that the user message information corresponds with the policy comprises identifying, within the set of policies, a content taxonomy corresponding to the keyword.

4. The computer-implemented method of claim 1, wherein accessing the user message information corresponding to the user query comprises monitoring a conversation of the generative artificial intelligence model, and wherein determining that the user message information corresponds with the policy comprises identifying a match criterion for the policy based on the conversation.

5. The computer-implemented method of claim 1, further comprising removing the policy guidance from a thread of the generative artificial intelligence model after the generative artificial intelligence model generates the response to the user query.

6. The computer-implemented method of claim 1, further comprising updating the policy database by adding a new policy to the set of policies.

7. The computer-implemented method of claim 1, further comprising updating the policy database by modifying at least one policy of the set of policies without modifying parameters of the generative artificial intelligence model.

8. The computer-implemented method of claim 1, further comprising preventing the generative artificial intelligence model from issuing the response to the user query.

9. The computer-implemented method of claim 1, further comprising providing, for display via a graphical user interface of a client device, a supplemental message with the response to the user query based on the policy.

10. A system comprising:
at least one processor; and
a non-transitory computer-readable storage medium comprising instructions that, when executed by the at least one processor, cause the system to perform operations comprising:
receiving, from a large language model, user message information corresponding to a user query;
comparing the user message information with a set of policies for the large language model;
determining that the user message information satisfies a match to a policy of the set of policies; and
sending, to the large language model for tailoring a response to the user query, a policy guidance message associated with the policy.

11. The system of claim 10, wherein:
receiving the user message information corresponding to the user query comprises monitoring a conversation of the large language model;
comparing the user message information with the set of policies comprises comparing a portion of the conversation of the large language model with match criteria for the set of policies;
determining that the user message information satisfies the match to the policy comprises identifying a match criterion within the match criteria that corresponds to the portion of the conversation; and
sending the policy guidance message to the large language model comprises generating a temporary system message for the large language model stating the policy guidance message.

12. The system of claim 10, wherein the operations further comprise deleting the policy guidance message from a thread of the large language model after the large language model generates the response to the user query.

13. The system of claim 10, wherein the operations further comprise updating a policy database with a new policy for the set of policies.

14. The system of claim 10, wherein the operations further comprise updating a policy database with a change to at least one policy of the set of policies without changing the large language model.

15. A non-transitory computer-readable storage medium comprising instructions that, when executed by at least one processor, cause a computing device to perform operations comprising:
receiving, from a generative artificial intelligence model, user message information corresponding to a user query;
comparing the user message information with a set of policies for the generative artificial intelligence model;
determining that the user message information matches a policy match criterion of a policy from the set of policies; and
sending a temporary system message with policy guidance for the policy to the generative artificial intelligence model.

16. The non-transitory computer-readable storage medium of claim 15, wherein the operations further comprise deleting the temporary system message from a thread of the generative artificial intelligence model after the generative artificial intelligence model generates a response to the user query.

17. The non-transitory computer-readable storage medium of claim 15, wherein the operations further comprise adding a new policy to the set of policies.

18. The non-transitory computer-readable storage medium of claim 15, wherein the operations further comprise modifying at least one policy of the set of policies without modifying the generative artificial intelligence model.

19. The non-transitory computer-readable storage medium of claim 15, wherein:
receiving the user message information corresponding to the user query comprises monitoring a conversation of the generative artificial intelligence model;
comparing the user message information with the set of policies comprises comparing a portion of the conversation of the generative artificial intelligence model with match criteria for the set of policies; and
determining that the user message information matches the policy match criterion comprises identifying the policy match criterion from the match criteria based on the portion of the conversation.

20. The non-transitory computer-readable storage medium of claim 15, wherein the operations further comprise:
providing, for display via a graphical user interface of a client device, a supplemental message with a response to the user query based on the policy; or
preventing the generative artificial intelligence model from issuing the response to the user query based on the policy.
